(19) United States
(12) Patent Application Publication
(10) Pub. No.: US 2023/0112023 A1
(43) Pub. Date: Apr. 13, 2023

(54) ELECTRODE ASSEMBLY

(71) Applicant: Samsung SDI Co., Ltd., Yongin-si, Gyeonggi-do (KR)

(72) Inventors: Dong Hyun SHIN, Yongin-si (KR); Da Un HAN, Yongin-si (KR); Yong Kyun PARK, Yongin-si (KR)

(21) Appl. No.: 17/912,816

(22) PCT Filed: Mar. 18, 2021
(86) PCT No.: PCT/KR2021/003373

§ 371 Date: Sep. 19, 2022

(30) Foreign Application Priority Data
Mar. 20, 2020 (KR) 10-2020-0034585

(51) Int. Cl. H01M 50/533; H01M 50/54

(52) U.S. Cl. CPC H01M 50/533; H01M 50/54

(57) ABSTRACT

The purpose of the present invention is to provide an electrode assembly which is prevented from being damaged due to electrode plate expansion during charging and discharging and thus has improved stability. According to the present invention, a guide line for guiding a portion to be welded in consideration of the expansion rate of an electrode plate is provided in an electrode tab, and thus there is an advantage in that damage due to expansion of the electrode plate during repeated charging and discharging can be prevented.

### TECHNICAL FIELD

An embodiment of the present invention relates to an electrode assembly for a secondary battery.

### BACKGROUND ART

In general, unlike a primary battery that cannot be charged, a secondary battery is a battery that can be charged and discharged. The secondary battery may be used in the form of a single battery depending on the type of external device to be applied, or may be used in the form of a battery module in which a plurality of batteries are connected and bundled as a unit.

In addition to being used as a power source for small electronic devices, such as mobile phones and notebook computers, secondary batteries are used in large transportation means, such as hybrid vehicles, and thus demands for high-output and high-capacity batteries are rapidly increasing.

In order to supply sufficient power to an electronic device or transportation means, the structure of a secondary battery itself should be stably designed. In particular, during repeated charging and discharging of a secondary battery, problems, such as tearing of an electrode plate of an electrode assembly or breakage of a substrate tab may occur, and thus there is a need to solve a problem of reduction in the cell stability.

The above information disclosed in this Background section is only for enhancement of understanding of the background of the invention and therefore it may contain information that does not constitute prior art.

### DESCRIPTION OF EMBODIMENTS

### Technical Problem

It is an object of the present invention to provide an electrode assembly which is prevented from being damaged due to expansion of an electrode plate during charging and discharging and thus has improved stability.

### Solution to Problem

An electrode assembly according to an embodiment of the present invention may include: a plurality of electrode plates including a substrate tab and having first guide lines for guiding a welding position on the substrate tab; and a plurality of separators interposed between the electrode plates, wherein the length (L_{N}) of the substrate tab from an N-th electrode plate to the guide lines is obtained by the formula below:

a²+[α×(N−1)×{Σ(electrode active material layer thickness×ε)+A}]²≤L_{N}²≤a²+[α×(N+1)×{Σ(electrode active material layer thickness×ε)+A}]²

where a is the length of the substrate tab of the electrode plate disposed on a first layer, α is a weight value with a bending process taken into consideration, N is the layer number of the electrode plate, E is the expansion rate of a corresponding electrode plate, and

A is Σcurrent collector thickness+Σseparator thickness.

The substrate tab may include a protrusion having a minimum protrusion length exposed to the outside of the separator.

The length (L4) of the substrate tab may be a length ranging from the protrusion to the first guide line.

A second guide line for guiding a position at which the substrate tab is bent may be formed on the substrate tab.

The substrate tab may include a protrusion having a minimum protrusion length exposed to the outside of the separator.

The substrate tab may have an increasing length (l′) from the protrusion to the second guide line increases as the stack number of electrode plates increases.

In addition, the present invention provides an electrode assembly comprising: an electrode plate including a substrate tab having a guide line for guiding a welding position and having a plurality of electrode plates stacked; and a plurality of separators respectively interposed between the electrode plates, wherein the substrate tab includes a protrusion having a minimum protrusion length exposed to the outside of the separators, the length from an end of the protrusion of the substrate tab of the N-th electrode plate to the guide line is greater than or equal to the length from the end of the protrusion of the substrate tab of the N-th electrode plate to the guide line, and is less than or equal to the length from the end of the protrusion of the substrate tab of the (N+1)-th electrode plate to the guide line.

The length (L_{N}) of the substrate tab from an N-th electrode plate to the guide lines is obtained by the formula below:

a²+[α×(N−1)×{Σ(electrode active material layer thickness×ε)+A}]²≤L_{N}²≤a²+[α×(N+1)×{Σ(electrode active material layer thickness×ε)+A}]²

wherein

a: length of substrate tab of electrode plate disposed on first layer; α: weight value considering bending process; N: layer number of electrode plate; ε: expansion rate of corresponding electrode plate; and A: Σcurrent collector thickness+Σseparator thickness.

A bending guide line for guiding a position where the substrate tab is bent may be formed on the substrate tab.

The substrate tab may increase as the length (l′) from the protrusion to the bending guide line increases as the number of stacks of the electrode plate increases.

### Advantageous Effects of Disclosure

According to an embodiment of the present invention, since the electrode tab includes a guide line for guiding a portion to be welded in consideration of the electrode plate expansion rate, there is an effect of preventing damage due to the expansion of the electrode plate during repeated charging and discharging.

In the present invention, since a welding guide line is formed in consideration of an electrode plate expansion rate, the high expansion rate of the negative electrode plate to which the silicon-based material is applied can be coped with, during charging and discharging, thereby preventing the electrode plate from being damaged and improving the stability of the electrode assembly.

### BRIEF DESCRIPTION OF DRAWINGS

FIG. 1 is a schematically enlarged side cross-sectional view of the structure of a general electrode assembly.

FIG. 2 is a photograph showing an example of cell damage when an electrode plate of a general electrode assembly is expanded.

FIG. 3 is an exploded perspective view schematically illustrating a structure of an electrode assembly according to an embodiment of the present invention.

FIG. 4 is an assembled perspective view of the electrode assembly according to FIG. 3.

FIG. 5 is a diagram schematically illustrating a substrate tab of the electrode assembly according to FIGS. 3 and 4.

FIG. 6 is a schematically enlarged side cross-sectional view of the structure of the electrode assembly according to FIG. 4.

FIG. 7 is a diagram illustrating an element for estimating a position of a first guide line of a second layer substrate tab in the electrode assembly according to FIG. 6.

FIG. 8 is a diagram illustrating an element for estimating a position of a first guide line of a third layer substrate tab in the electrode assembly according to FIG. 6.

FIG. 9 is a graph showing the length of the substrate tab for each layer of the electrode assembly according to FIGS. 7 and 8, for each expansion rate.

FIG. 10 is a graph showing the length addition amount of the substrate tab for each layer of the electrode assembly according to FIGS. 7 and 8, for each expansion rate.

FIGS. 11 to 14 are tables showing the length of the substrate tab for each electrode plate expansion rate of the electrode assembly according to an embodiment of the present invention.

FIG. 15 is a view showing elements for calculating a position of a second guide line in the electrode assembly according to FIG. 5 of the present invention.

### BEST MODE

Example embodiments of the present invention are provided to more completely explain the present invention to a person skilled in the art. The following embodiments may be modified in various different forms, but the scope of the present invention is not limited to the following embodiments. Rather, these embodiments are provided so that this disclosure will be more thorough and complete, and will fully convey the spirit of the invention to a person skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, before describing the electrode assembly according to the embodiment of the present invention with reference to the accompanying drawings, a general electrode assembly structure will be first described.

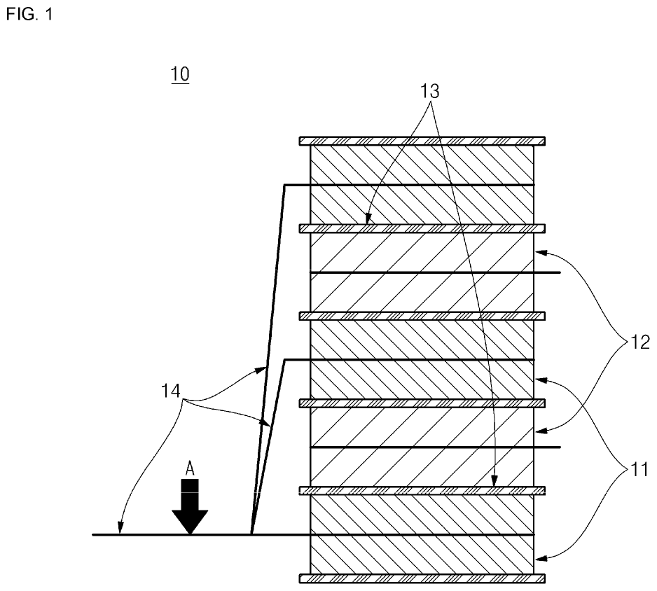

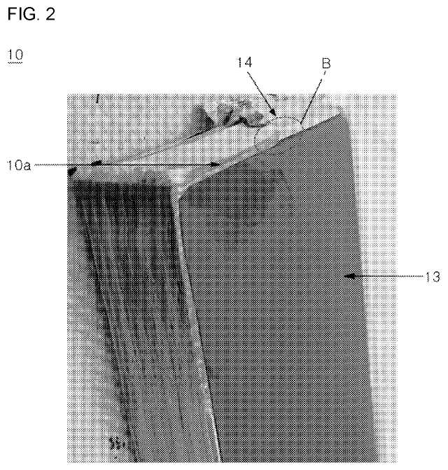

FIG. 1 is a schematically enlarged side cross-sectional view of the structure of a general electrode assembly. FIG. 2 is a photograph showing an example of cell damage when an electrode plate of a general electrode assembly is expanded.

As shown in FIG. 1, in general, the stacked electrode assembly 10 has a structure in which a negative electrode plate 11 formed by coating a negative active material on both sides of a substrate, a positive electrode plate 12 formed by coating a positive active material on both sides of the substrate, and a separator 13 inserted between the negative electrode plate 11 and the positive electrode plate 12, sequentially stacked. A positive electrode substrate tab and a negative electrode substrate tab, each without an active material coated thereon, are respectively formed at first ends of the negative electrode plate 11 and the positive electrode plate 12 to be electrically connected to external electrode terminals. The structures and welding methods of the positive electrode substrate tab and the negative electrode substrate tab are the same, and thus the positive electrode substrate tab and the negative electrode substrate tab are collectively described as a substrate tab 14.

During welding of the substrate tabs 14, on the basis of FIG. 1, the substrate tabs 14 are bent and closely adhered to the lowermost end, and the closely adhered parts thereof are collected to then be welded. To this end, the farther away from the lowermost substrate tab 14, the longer the tab length.

The expansion rate of the electrode plate (positive electrode plate and negative electrode plate) of the electrode assembly varies depending on the number of repeated charging and discharging, the type of electrode plate material, and the content of the electrode plate material. However, the substrate tab has a fixed welding portion (A), and, when setting the length of the substrate tab, is not designed in consideration of the expansion rate of the electrode plate. Therefore, if the expansion rate of the electrode plate is high, tearing of the electrode plate around the substrate tab may occur. A photograph showing a state in which an electrode plate is damaged due to the expansion of the electrode plate is shown in FIG. 2 by way of example.

As shown in FIG. 2, when an electrode plate 10a is expanded, the electrode plate 10a around the substrate tab 14 fixed by welding may be torn (see a portion B in FIG. 2), a curl may occur at an end thereof, so that an active material may be delaminated, or the substrate tab 14 may be broken.

Recently, in order to provide a high-capacity secondary battery, a silicon material is increasingly applied to an active material layer of a negative electrode plate, and thus, compared to a negative electrode plate using graphite alone, the expansion rate of the active material layer is relatively high, leading to increasingly frequent occurrence of this problem.

Therefore, an electrode assembly should be designed so as to prevent an electrode plate or the substrate tab from being damaged even in the case of using a negative electrode plate with a silicon (Si) material having a high expansion rate applied thereto.

Hereinafter, an electrode assembly according to an embodiment of the present invention that can solve the above problems will be described.

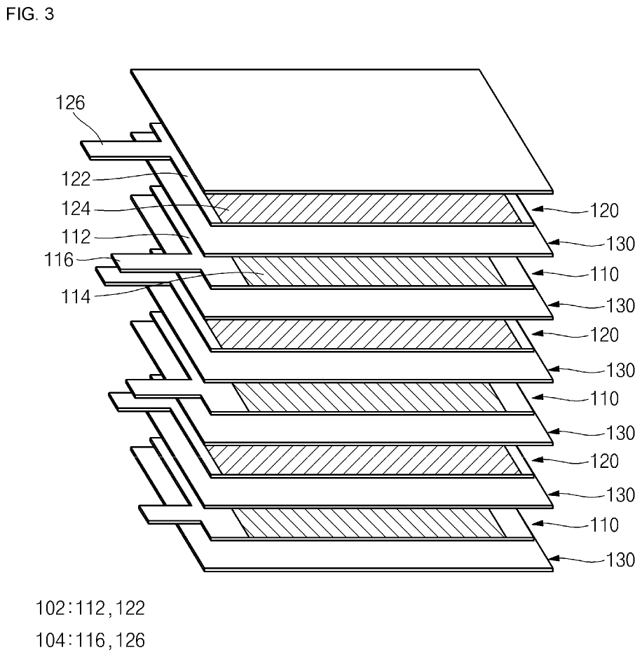

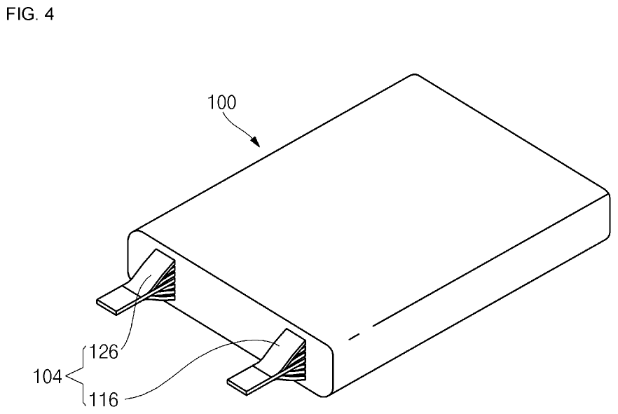

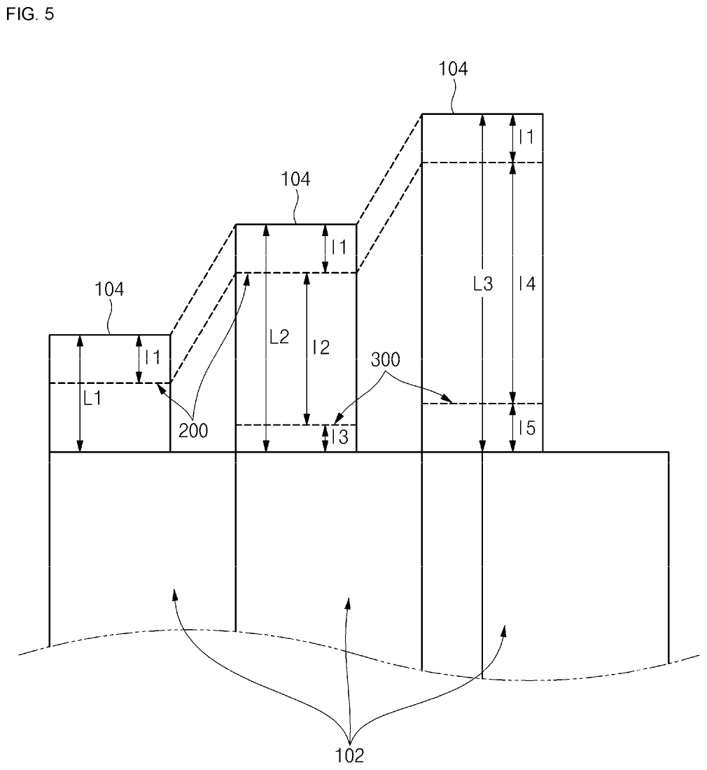

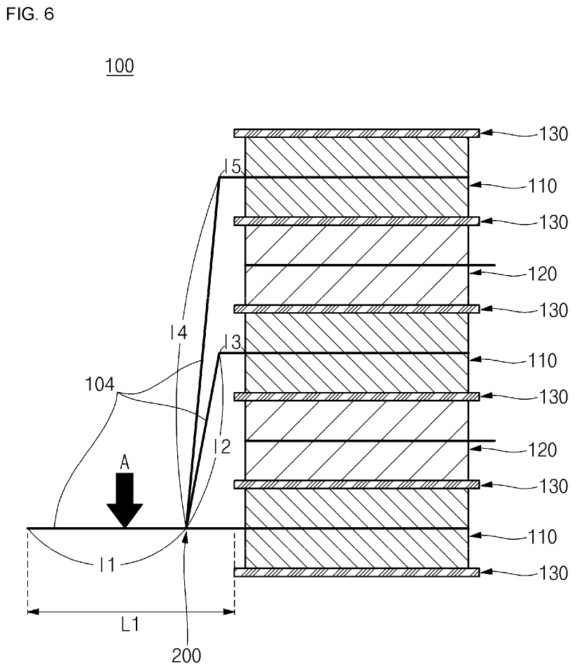

FIG. 3 is an exploded perspective view schematically illustrating a structure of an electrode assembly according to an embodiment of the present invention. FIG. 4 is an assembled perspective view of the electrode assembly according to FIG. 3. FIG. 5 is a diagram schematically illustrating a substrate tab of the electrode assembly according to FIGS. 3 and 4. FIG. 6 is a schematically enlarged side cross-sectional view of the structure of the electrode assembly according to FIG. 4 (Hereinafter, on the basis of FIG. 6, the following description will be made on the assumption that the bottommost layer is a first layer, and electrode plates stacked thereon are sequentially increased in layer number).

As shown in FIGS. 3 and 4, the electrode assembly 100 according to an embodiment of the present invention includes a plurality of negative electrode plates 110 and positive electrode plates 120, and a plurality of interposed separators 130 respectively interposed between the negative electrode plates 110 and the positive electrode plate 120. The electrode assembly 100 may be formed in the form of a stack in which the negative electrode plates 110, the positive electrode plates 120, and the separators 130 are stacked.

The negative electrode plate 110 includes a negative electrode substrate 112, a negative electrode active material layer 114, and a negative electrode substrate tab 116. The negative electrode substrate 112 is referred to as a negative current collector, and a negative electrode active material layer 114 is formed on both sides thereof. A negative electrode substrate tab 116 electrically connected to an external terminal is formed on one side of the negative electrode substrate 112 where the negative electrode active material layer 114 is not formed.

The positive electrode plate 120 includes a positive electrode substrate 122, a positive electrode active material layer 124, and a positive electrode substrate tab 126. The positive electrode substrate 122 is referred to as a positive electrode current collector, and a positive electrode active material layer 124 is formed on both sides thereof. A positive electrode substrate tab 126 is formed on one side of the positive electrode substrate 122 where the positive electrode active material layer 124 is not formed.

The separator 130 interposed between the negative electrode plate 110 and the positive electrode plate 120 has a plate shape and insulates the negative electrode active material layer 114 and the positive electrode active material layer 124 from being electrically connected. The separator 130 is disposed between each of the plurality of negative electrode plates 110 and each of the positive electrode plates 120.

The negative electrode substrate 112 and the positive electrode substrate 122 are collectively referred to as a substrate 102, and the negative electrode substrate tab 116 and the positive electrode substrate tab 126 are combined to be defined as a substrate tab 104. In a state in which the negative electrode plate 110 and the positive electrode plate 120 are disposed with the separator 130 interposed therebetween, the negative electrode substrate tab 116 and the positive electrode substrate tab 126 are formed to be spaced apart from each other by a predetermined distance.

As shown in FIG. 3, the electrode assembly 100 has a plurality of negative electrode plates 110, a plurality of positive electrode plates 120, and a plurality of separators 130 sequentially stacked in the order of the negative electrode plate 110, the separator 130, the positive electrode plate 120, and the separator 130 (The order of negative electrode plates and positive electrode plates may be changed). In this stacked state, the negative electrode substrate tabs 116 are collected and welded, and the positive electrode substrate tabs 126 are collected and welded to then be connect to external terminals.

The negative electrode substrate tab 116 and the positive electrode substrate tab 126 may have shapes physically the same or similar to each other, and thus will now be referred to as the substrate tabs 104, for convenience. The structures of the substrate tabs 104 to be described below may be applied to both the negative electrode substrate tab 116 and the positive electrode substrate tab 126.

As shown in FIG. 5, the substrate tabs 104 may extend from one side of each of the substrates 102, and for the convenience of welding, guide lines may be formed on the substrate tabs 104.

For example, the guide lines may be formed to guide the welding portion (A) where welding is made when a plurality of substrate tabs 104 are collected and welded. A guide line for guiding the welding portion A is defined as a first guide line 200.

The first guide line 200 may be formed in various manners, including, for example, forming marks on the substrate tabs 104 by applying linear pressure on the substrate tabs 104, or drawing on the surfaces of the substrate tabs 104 by using a special paint.

If necessary, a second guide line 300 spaced apart from the first guide line 200 and close to the substrate 102 may be additionally formed. In this case, the second guide line 300 may be formed only on the substrate tabs 104 of the substrate 102 stacked on top of the electrode assembly 100 in the form of a stack. The second guide line 300 is formed to facilitate folding or bending of the plurality of substrate tabs 104 when the plurality of substrate tabs 104 are collected and welded, as shown in FIG. 6. However, since the substrate tabs 104 disposed above are not necessarily welded after being folded or bent, forming of the second guide line 300 may not be essential (a method of obtaining the formation position of the second guide line will later be described).

Referring to FIG. 6, The first guide line 200 is formed for guiding the welding portion A. The welding portion A is a portion ranging from the first guide line 200 to the end of the substrate tabs 104. That is, the welding portion A is formed outside the first guide line 200.

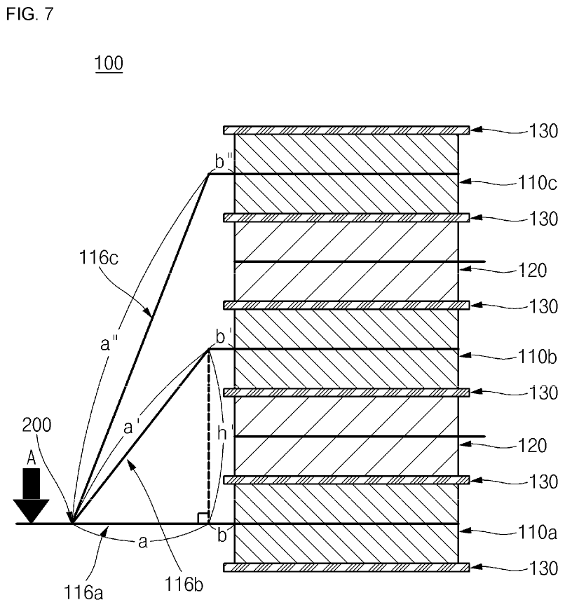

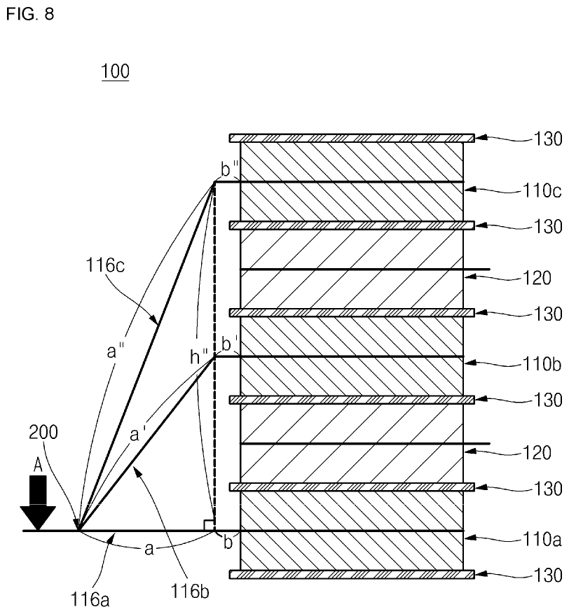

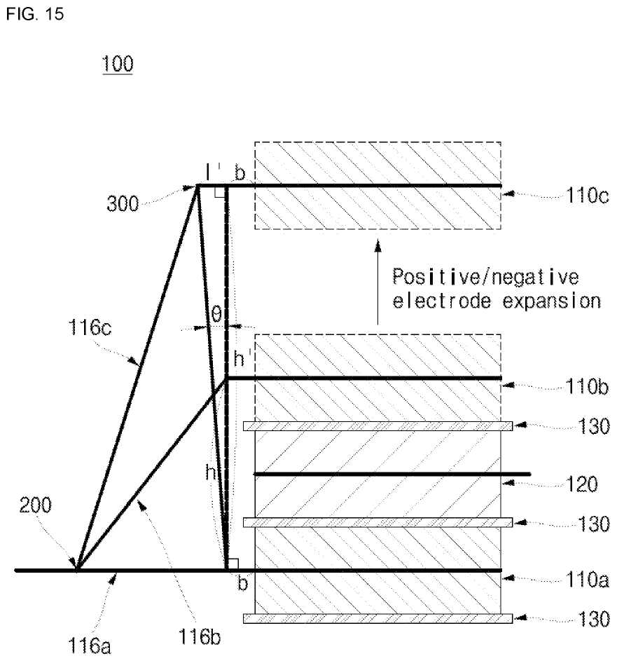

For example, from the bottom, the first substrate tab 104, the third substrate tab 104, and the fifth substrate tab 104, are tabs having the same polarity, and, for welding, the substrate tabs 104 can be welded together towards the bottommost substrate tab 104. Here, as shown in FIGS. 5 and 6, the length (L2=l1+l2+l3) of the third substrate tab 104 should be greater than the length (L1) of the first substrate tab 104, and the length (L3=l1+l4+l5) of the fifth substrate tab 104 should be greater than the length (L2) of the third substrate tab 104. In addition, the lengths (l1) of portions where the welding portion A is formed may be equal to each other (where l3 and l5 are different from b, b′, and b″ of FIGS. 7 and 8, which will later be described, and are concepts corresponding to l′ of FIG. 15, which will later be described).

In particular, it is preferable to set the length (L) of the substrate tabs 104 in consideration of the expansion rate of the substrate 102 to prevent the substrate tabs 104 or the substrate 102 around the substrate tabs 104 from being damaged even when the substrate 102 is expanded. Hereinafter, a method of calculating the length (L) of the substrate tabs 104 will be described.

FIG. 7 is a diagram illustrating an element for estimating a position of a first guide line of a second layer substrate tab in the electrode assembly according to FIG. 6. FIG. 8 is a diagram illustrating an element for estimating a position of a first guide line of a third layer substrate tab in the electrode assembly according to FIG. 6.

In the description with reference to FIGS. 7 and 8, for convenience, the method of calculating the length of a substrate tab on the basis of the negative electrode substrate tab 116 will be described (The length of the positive substrate tab may also be calculated in the same manner).

As shown in FIG. 7, with respect to the bottom, the negative substrate tab 116a of the first negative electrode plate 110a located at the bottom is set to a basic length that does not reflect the expansion rate, which is because, in the first negative electrode plate 110a located in the first layer, there is no significant change in the position of the negative electrode substrate tab 116a even when the negative electrode plate is expanded. However, the lengths of the second cathode 110b located in the third layer and the third negative electrode plate 110c located in the fifth layer are set in consideration of both the expansion rates of the negative electrode plate 110 and the positive electrode plate 120.

As a prerequisite, the lengths (b, b′, b″) of the negative electrode substrate tab 116a ranging to bent portions while being collected to one side are all the same. Here, b, b′, and b″ refer to minimum lengths that allow the electrode tabs to protrude out of the separators, and are hereinafter defined as the “minimum protrusion length” of each electrode tab. In addition, the b, b′, and b″ portions each having the minimum protrusion length are defined as ‘protrusions’ (b, b′, and b″ being different from l3 and l5 in FIGS. 5 and 6).

Here, according to the Pythagorean theorem, the length of each portion of the negative electrode substrate tab 116a of the first negative electrode plate 110a and the negative electrode substrate tab 116b of the second negative electrode plate 110b has the following formula:

a²+h′²=a′² [Formula 1]

where a is the length of the negative electrode substrate tab 116a of the first negative electrode plate 110a minus the minimum protrusion length (b) from the length to the first guide line 200 (because the negative electrode substrate tab of the first negative electrode plate is not bent, but b=b′=b″). h′ is the height from the negative electrode substrate tab 116a of the first negative electrode plate 110a to the negative electrode substrate tab 116b of the second negative electrode plate 110b. a′ corresponds to the hypotenuse of an isosceles triangle whose base and height are a and h′, respectively. a′ is an element necessary to form the first guide line 200 for welding on the negative electrode substrate tab 116b of the second negative electrode plate 110b.

If the values of a and h′ are known according to the Pythagorean theorem, the length of a′ required in the negative substrate tab 116b of the second negative electrode plate 110b can be obtained. The value of a can be known through the length of the existing negative electrode substrate tab 116 that does not consider the expansion rate, and h′ can be obtained as follows with reference to FIG. 7.

h′=α×(N_{L}−1)×[(Tₚ−T_{pc})×ϵₚ+(Tₙ−T_{nc})×ϵₙ+T_{pc}+T_{nc}+Tₛ×2] [Formula 2]

where N_{L} is the layer number of the stacked negative electrode plate 110 or positive electrode plate 120 (in FIG. 7, the negative electrode is a reference), and Tₙ, Tₚ, and Tₛ are the thicknesses of the negative electrode plate 110, the positive electrode plate 120, and the separator 130, respectively. In addition, T_{nc} and T_{pc} are the thicknesses of the substrate of the negative electrode plate 110 and the substrate of the positive electrode plate 120, respectively, and εₙ εₚ are the expansion rates of the negative electrode plate 110 and the positive electrode plate 120, respectively. α(alpha) is a weight for a bending process, and is an arbitrary constant value determined according to the stack thickness of the electrode assembly 100 and the number of layers. Therefore, the value obtained by subtracting T_{pc} from Tₚ is the thickness of the positive electrode active material layer, and the value obtained by subtracting T_{nc} from Tₙ is the thickness of the negative electrode active material layer.

h′ can be obtained according to the above-mentioned formula, and h″ of the third negative electrode plate 110c in FIG. 8 can also be obtained in the same manner.

When h′ is obtained in this manner, as described above, a′ of the second negative electrode plate 110b may be obtained according to the Pythagorean theorem, and thus the first guide line 200 may be formed on the negative electrode substrate tab 116 of the second negative electrode plate 110b. In the same manner, a″ of the negative electrode substrate tab 116c of the third negative electrode plate 110c may also be obtained, and the first guide line 200 may be formed on the negative electrode substrate tab 116c of the third negative electrode plate 110c.

In addition, on the basis of the negative electrode substrate tab 116b of the second negative electrode plate 110b, the length (a′) of the negative electrode substrate tab 116b from the end of the protrusion having the minimum protrusion length (b′) to the first guide line 200 may be defined as follows:

a²+h′²≤a′²≤a²+h′² [Formula 3]

On the basis of formulas 2 and 3 above, the formula for calculating the length of the electrode tab up to the first guide line formed on the electrode tab of the N-th electrode (which means the length from the end of b′ (protrusion) to the first guide line when the second negative electrode is described as an example, referred to as L_{N}, hereinafter) is generalized and expressed as follows:

a²+[α×(N−1)×{Σ(electrode active material layer thickness×ε)+A}]²≤L_{N}²≤a²+[α×(N+1)×{Σ(electrode active material layer thickness×ε)+A}]² [Formula 4]

where a is the electrode tab length of the electrode plate disposed on the first layer, α is a weight value with a bending process taken into consideration, and N is the layer number of the electrode plate. ε is the expansion rate of the electrode plate, and A is the sum of the thickness of the current collector and the sum of the thickness of the separator (Σ current collector thickness+Σseparator thickness).

When the negative electrode plate 110 and the positive electrode plate 120 expand, the height in the stacking direction of the electrode assembly 100 increases. Therefore, except for the first negative electrode plate 110a, the negative electrode plate 110 and the positive electrode plate 120 stacked thereon must be manufactured to increase the length of the substrate tabs 104 as the thickness increases by expansion. In particular, as the positive electrode plate 120 is disposed between the negative electrode plates 110 and the negative electrode plate 110 is disposed between the positive electrode plates 120, the increase in the length of the substrate tabs 104 should be considered together with the expansion of the negative electrode plate 110 and the positive electrode plate 120. In particular, when a high expansion material, such as silicon (Si), is used for the negative electrode, the length of the substrate tabs 104 for each layer should be designed differently according to the expansion rate. This will be described in more detail on the basis of specific examples.

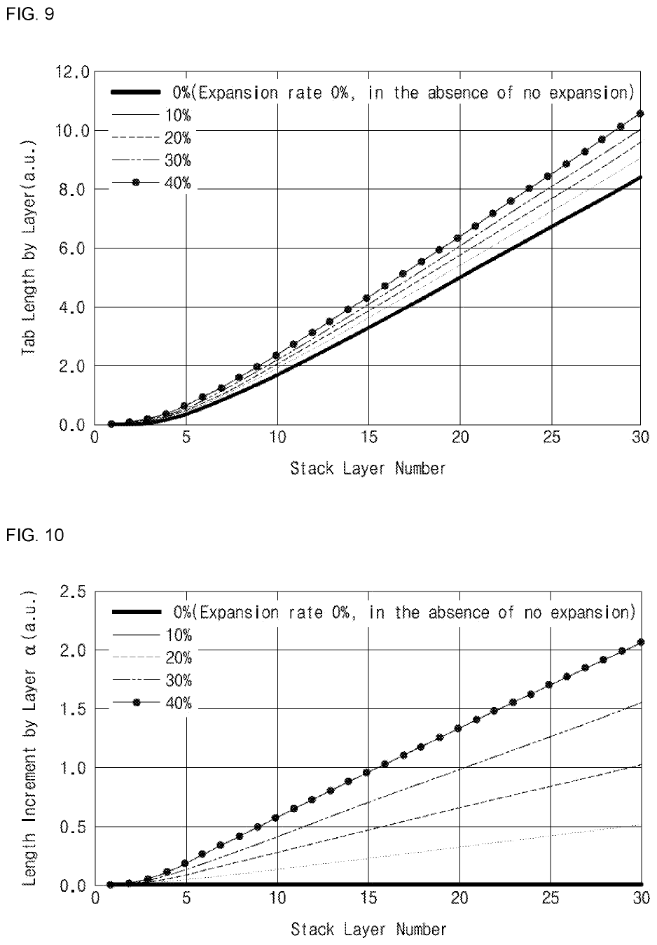

FIG. 9 is a graph showing the length of the substrate tab for each layer of the electrode assembly according to FIGS. 7 and 8, for each expansion rate. FIG. 10 is a graph showing the length addition amount of the substrate tab for each layer of the electrode assembly according to FIGS. 7 and 8, for each expansion rate.

As shown in FIG. 9, when viewed on the basis of the negative electrode plate 110 shown in FIGS. 7 and 8 by way of example, as the stack layer number of the electrode assembly to be stacked increases (on the basis of FIG. 7, stacked from the bottom to the top), the length of the substrate tab for each layer should be increased. Even with the same stack layer, the higher the expansion rate, the longer the substrate tab should be.

Therefore, as shown in FIG. 10, the length of the substrate tab should be set in consideration of the additional length (a) of the substrate tab for each layer according to the expansion rate. The additional length (a) of the substrate tab for each layer is obtained by subtracting the length from the length of the substrate tab of the next layer to the first guide line 200 to the length of the substrate tab of the previous layer to the first guide line 200. For example, the additional length of the substrate tabs 104 of the second negative electrode plate 110b of FIG. 7 can be obtained as (a′+b′)-(a+b). In the same manner, the additional length (α) of the substrate tab of another layer can be obtained.

FIGS. 11 to 14 are tables showing the length of the substrate tab for each electrode plate expansion rate of the electrode assembly according to an embodiment of the present invention. (Reference numerals for components not shown in FIGS. 11 to 14 will be described with reference to FIGS. 7 and 8.)

The positive electrode plate of the electrode assembly may be classified into LCO (lithium cobalt oxide), NCA (nickel, cobalt, aluminum), NCM (nickel, cobalt, manganese) type, etc. according to the type of active material.

FIG. 11 is a table showing the lengths of the negative electrode substrate tab added by calculating the length increment, for expansion rates of a positive electrode plate having an initial electrode thickness of 100 microns and a negative electrode plate having an initial electrode thickness of 150 microns, when the weight a of the bending process is set to 1, assuming that the type of the positive electrode active material is LCO, and the length of a of FIG. 7 (portion a of the negative electrode substrate tab of the first negative electrode plate) is 2 mm.

Referring to FIG. 11, it is confirmed that the length of the substrate tabs 104 must be increased according to the expansion rates of the negative electrode plate 110 and the positive electrode plate 120, compared to the existing substrate tab length that does not consider the expansion rates of the negative electrode plate 110 and the positive electrode plate 120. In particular, as the electrode plate expansion rate of the negative electrode plate 110 increases, the length of the substrate tabs 104 should also increase accordingly.

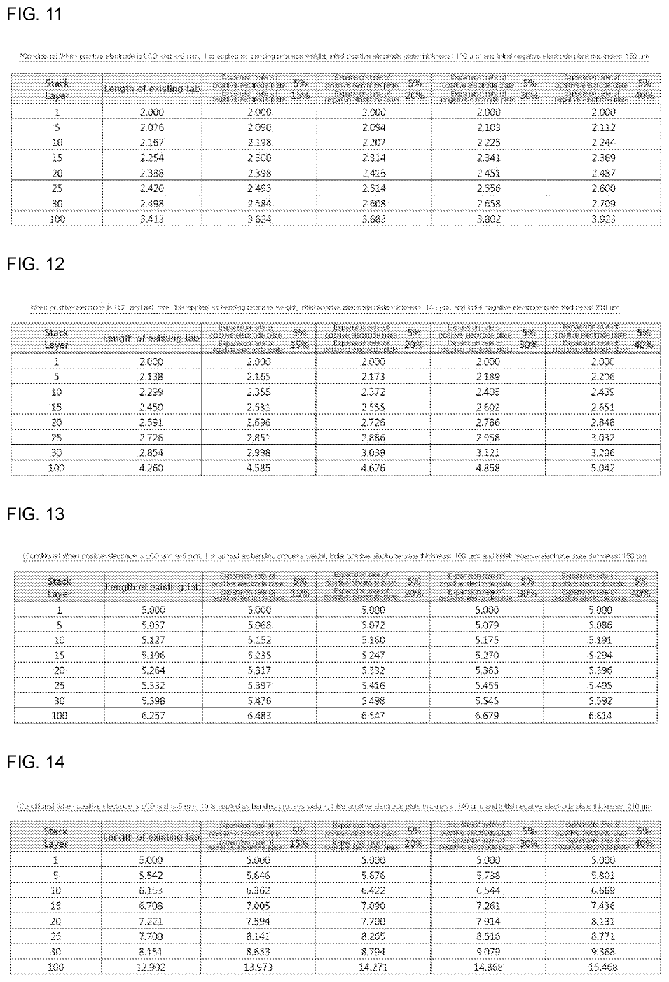

FIG. 12 is a table showing the lengths of the negative electrode substrate tab added by calculating the length increment, for expansion rates of a positive electrode plate having an initial electrode thickness of 140 microns and a negative electrode plate having an initial electrode thickness of 210 microns, when the weight a of the bending process is set to 1, assuming that the type of the positive electrode active material is LCO, and a of FIG. 7 is 2 mm.

Referring to FIG. 12, under the same conditions as in FIG. 11, the length of the substrate tabs 104 can be known in examples in which the thicknesses of the negative electrode plate 110 and the positive electrode plate 120 are increased. According to FIG. 12, it is confirmed that when the thicknesses of the negative electrode plate 110 and the positive electrode plate 120 are increased, the required length of the substrate tabs 104 increases according to the thickness increment, and, considering the expansion rate, the required length of the substrate tabs 104 should be greater than the length of the existing substrate tab, compared to the embodiment of FIG. 11.

FIG. 13 is a table showing the lengths of the negative electrode substrate tab added by calculating the length increment, for expansion rates of a positive electrode plate having an initial electrode thickness of 140 microns and a negative electrode plate having an initial electrode thickness of 210 microns, when the weight a of the bending process is set to 1, assuming that the type of the positive electrode active material is LCO, and a of FIG. 7 is 5 mm.

FIG. 13 shows an embodiment in which the length of an existing substrate tab itself is increased in response to the increased thickness, compared to FIG. 11. It is confirmed that, although the increase in the length of the substrate tabs 104 is smaller than in the embodiment of FIG. 12, considering the expansion rates of the negative electrode plate 110 and the positive electrode plate 120, the required length of the substrate tabs 104, in the embodiment of FIG. 13, should also be greater than the length of the existing substrate tab.

FIG. 14 is a table showing the lengths of the negative electrode substrate tab added by calculating the length increment, for expansion rates of a positive electrode plate having an initial electrode thickness of 140 microns and a negative electrode plate having an initial electrode thickness of 210 microns, when the weight a of the bending process is set to 1, assuming that the type of the positive electrode active material is LCO, and a of FIG. 7 is 5 mm.

FIG. 14 shows an embodiment in which the weight of the length-bending process of an existing substrate tab is increased in response to the increased thickness, compared to FIG. 11. Referring to FIG. 14, it is confirmed that, although the length of the substrate tabs 104 is increased by increasing the weight of the bending process, considering the expansion rates of the negative electrode plate 110 and the positive electrode plate 120, the required length of the substrate tabs 104, in the embodiment of FIG. 14, should also be greater than the length of the existing substrate tab.

That is, as shown in FIGS. 11 to 14, it is confirmed that the length of the substrate tabs 104 should be increased as the number of stacked layers of the negative electrode plate 110 and the positive electrode plate 120 and the initial thickness of the substrate 102 increase, and considering the expansion rates of the negative electrode plate 110 and the positive electrode plate 120, the length of the substrate tabs 104 should be additionally increased.

As described above, considering the expansion rates of the negative electrode plate and the positive electrode plate, by increasing the length of the substrate tab, compared to a case where the expansion rates are not considered, it is possible to prevent damage, such as tearing of the electrode plate near the substrate tab due to the expansion of the electrode plate. In addition, since the length of the substrate tab is designed in consideration of the expansion rate of the electrode plate, damage to the substrate tab due to the expansion of the electrode plate can also be prevented.

Meanwhile, as shown in FIG. 5, as necessary, the above-described second guide line 300 may be formed on the substrate tabs 104, and the second guide line 300 may also be formed in various manners, including, for example, forming marks on the substrate tabs 104 by applying linear pressure to the substrate tabs 104, or drawing on the surfaces of the substrate tabs 104 by using a special paint.

As shown in FIG. 6, as the layers of the substrate 102 stacked increases, the substrate tabs 104 may be designed such that the lengths l3 and l5 (referred to as the bent portion length V, hereinafter) from the substrate 102 to bent portions protruding from the substrate 102 become gradually greater than the bent portion length (t) of the previous layer.

FIG. 15 is a view showing elements for calculating a position of a second guide line in the electrode assembly according to FIG. 5 of the present invention.

In FIG. 15, from the bottom, the first electrode may be a first negative electrode plate 110a, the second electrode may be a positive electrode plate, and the third electrode may be a second negative electrode plate 110b. As shown in FIG. 15, in a state in which the negative electrode plate 110 and the positive electrode plate 120 do not expand, the height ranging from the negative electrode substrate tab 116a of the first negative electrode plate 110a to the negative electrode substrate tab 116b of the second negative electrode plate 110b may be referred to as h. When the negative electrode plate 110 and the positive electrode plate 120 expand, and the second negative electrode plate 110b rises to a position of the third negative electrode plate 110c, indicated by the dotted line, the negative electrode substrate tab 116c positioned at the third negative electrode plate 110c requires a length increment as much as the bent portion length (l′). The portion protruding as much as the bent portion length (l′) is a bent portion, and thus the second guide line 300 may be formed on the corresponding portion of the negative electrode substrate tab 116.

Here, h′, r, and 6 (the angle between the height h and the bent portion) with the expansion rates of the negative electrode plate 110 and the positive electrode plate 120 taken into consideration have the following relationship.

$$tan θ = \frac{{ℓ}^{′}}{{h}^{′}} \qquad [ Formula 5 ]$$

where h′ may be obtained with reference to FIG. 15 as follows:

h′=(N_{L}−1)×[(Tₚ−T_{pc})×ϵₚ+(Tₙ−T_{nc})×ϵₙ+T_{pc}+T_{nc}+Tₛ×2] [Formula 6]

where N_{L} is the layer number of the stacked negative electrode plate 110 or positive electrode plate 120 (in FIG. 15, the negative electrode is a reference), and Tₙ, Tₚ, and Tₛ are the thicknesses of the negative electrode plate 110, the positive electrode plate 120, and the separator 130, respectively. In addition, T_{nc} and T_{pc} are the thicknesses of the substrate of the negative electrode plate 110 and the substrate of the positive electrode plate 120, respectively, and εₙ εₚ are the expansion rates of the negative electrode plate 110 and the positive electrode plate 120, respectively. Therefore, the value obtained by subtracting T_{pc} from Tₚ is the thickness of the positive electrode active material layer, and the value obtained by subtracting T_{nc} from Tₙ is the thickness of the negative electrode active material layer. In addition, θ may be determined according to the thickness of the electrode assembly 100 stack, the number of layers, and the bendable free space. The range of the θ angle proposed in this embodiment is in the range of 0 to 40 degrees (0≤θ≤40). However, as necessary, the range of the θ angle may be greater than or equal to 40 degrees.

Since h′ and tan θ can be obtained by the above-mentioned formulas, the bent portion length (l′) required for forming the second guide line 300 for guiding the bending position of the substrate tab 104 can be obtained. Therefore, in designing the length of the substrate tab 104, the position of the second guide line 300 with the expansion rate of the electrode plate taken into consideration can be calculated.

While the foregoing embodiment has been provided for carrying out the present invention, it should be understood that the embodiment described herein should be considered in a descriptive sense only and not for purposes of limitation, and various changes in form and details may be made therein without departing from the spirit and scope of the disclosure as defined by the following claims.

### INDUSTRIAL APPLICABILITY

The present invention may be used in an electrode assembly, a secondary battery or battery having an electrode assembly, and a battery module.

1. An electrode assembly comprising:
a plurality of electrode plates including a substrate tab and having first guide lines for guiding a welding position on the substrate tab; and
a plurality of separators interposed between the electrode plates,
wherein the length (L_{N}) of the substrate tab from an N-th electrode plate to the guide lines is obtained by the formula below:
a²+[α×(N−1)×{Σ(electrode active material layer thickness×ε)+A}]²≤L_{N}²≤a²+[α×(N+1)×{Σ(electrode active material layer thickness×ε)+A}]²
where a is the length of the substrate tab of the electrode plate disposed on a first layer, α is a weight value with a bending process taken into consideration, N is the layer number of the electrode plate, E is the expansion rate of a corresponding electrode plate, and A is Σcurrent collector thickness+Σseparator thickness.

2. The electrode assembly of claim 1, wherein the substrate tab includes a protrusion having a minimum protrusion length exposed to the outside of the separators.

3. The electrode assembly of claim 2, wherein the length (L4) of the substrate tab is a length ranging from the protrusion to the first guide line.

4. The electrode assembly of claim 3, wherein a second guide line for guiding a position at which the substrate tab is bent is formed on the substrate tab.

5. The electrode assembly of claim 4, wherein the substrate tab includes a protrusion having a minimum protrusion length exposed to the outside of the separator.

6. The electrode assembly of claim 5, wherein the substrate tab has an increasing length (l′) from the protrusion to the second guide line increases as the stack number of electrode plates increases.

7. An electrode assembly comprising:
an electrode plate including a substrate tab having a guide line for guiding a welding position and having a plurality of electrode plates stacked; and
a plurality of separators respectively interposed between the electrode plates,
wherein the substrate tab includes a protrusion having a minimum protrusion length exposed to the outside of the separators, the length from an end of the protrusion of the substrate tab of the N-th electrode plate to the guide line is greater than or equal to the length from the end of the protrusion of the substrate tab of the N-th electrode plate to the guide line, and is less than or equal to the length from the end of the protrusion of the substrate tab of the (N+1)-th electrode plate to the guide line.

8. The electrode assembly of claim 7, wherein the length (L_{N}) of the substrate tab from an N-th electrode plate to the guide lines is obtained by the formula below:
a²+[α×(N−1)×{Σ(electrode active material layer thickness×ε)+A}]²≤L_{N}²≤a²+[α×(N+1)×{Σ(electrode active material layer thickness×ε)+A}]²
where a is the length of the substrate tab of the electrode plate disposed on a first layer, α is a weight value with a bending process taken into consideration, N is the layer number of the electrode plate, E is the expansion rate of a corresponding electrode plate, and A is Σcurrent collector thickness+Σseparator thickness.

9. The electrode assembly of claim 7, wherein a bending guide line for guiding a position where the substrate tab is bent is formed on the substrate tab.

10. The electrode assembly of claim 9, wherein the substrate tab increases as the length (l′) from the protrusion to the bending guide line increases as the number of stacks of the electrode plate increases.
